(19) United States
(12) Patent Application Publication
(10) Pub. No.: US 2017/0206045 A1
(43) Pub. Date: Jul. 20, 2017

(54) INFORMATION PROVIDING APPARATUS FOR VEHICLE

(71) Applicant: TOYOTA JIDOSHA KABUSHIKI KAISHA, Toyota-shi (JP)

(72) Inventors: Tomohiro MATSUKAWA, Anjo-shi (JP); Toshinori AOKI, Toyota-shi (JP)

(73) Assignee: TOYOTA JIDOSHA KABUSHIKI KAISHA, Toyota-shi (JP)

(21) Appl. No.: 15/353,483

(22) Filed: Nov. 16, 2016

(30) Foreign Application Priority Data
Jan. 15, 2016 (JP) 2016-006337

(51) Int. Cl. G06F 3/14; B60R 1/00

(52) U.S. Cl. CPC G06F 3/14; B60R 1/00; G06T 11/00

(57) ABSTRACT

A first-screen is continuously displayed on a display according to contents of the first-screen, in a case where a first display request is cancelled before a continuous display time in which the first-screen based on the first display request has been continuously displayed on the display, reaches a predetermined reference time. Meanwhile, after display of the first-screen has been continued and before the continuous display time of the first-screen reaches the reference time, in a case where a second display request making an instruction for displaying a second-screen to be displayed at a highest priority occurs, the display is switched from the first-screen to the second-screen at a time when the second display request occurs, and, in a case where the second display request does not occur, the first-screen is displayed on the display until the continuous display time of the first-screen reaches the reference time.

### FIELD OF THE INVENTION

The present invention relates to information providing apparatuses mounted in vehicles.

### DESCRIPTION OF THE BACKGROUND ART

A technique in which a plurality of pieces of information are displayed on a screen of a display section that is limited in size, the number of pieces of information which can be simultaneously displayed, or the like, due to, for example, the display screen being small, is disclosed in, for example, Japanese Laid-Open Patent Publication No. 2012-098060 (hereinafter, referred to as Patent Literature 1).

In the method disclosed in Patent Literature 1, display priorities that change with the elapse of time are assigned to the plurality of pieces of information, respectively, and, for example, each time the display priority of any of the plurality of pieces of information is changed, predetermined number of pieces of information having high display priorities are selected and displayed on the screen. Thus, in Patent Literature 1, a phenomenon that new information cannot be displayed on a screen since old information continues to be displayed on the screen, is prevented from occurring.

In the method disclosed in Patent Literature 1, information having a high priority can be displayed on the screen in real time. For example, in a case where there are information A and information B having a display priority that is slightly lower than the information A, if only the information A is selected and displayed on the screen, and the display priority of the information B thereafter becomes higher than the display priority of the info illation A for a short time period, the information B is immediately displayed on the screen instead of the information A.

That is, if a screen to be displayed is determined simply based on only the priority of the information as in the method disclosed in Patent Literature 1, a phenomenon that the screen of the information A is displayed for an instant (hereinafter, referred to as “instantaneous display”, may occur. The instantaneous display of information not only prevents a driver from recognizing the contents of information displayed on the screen but also makes the driver feel uneasy or is bothersome.

### SUMMARY OF THE INVENTION

The present invention is made in view of the aforementioned problem, and an object of the present invention is to provide an information providing apparatus, for a vehicle, which can preferentially display, in real time, information having a high priority while inhibiting instantaneous display of information from occurring.

In order to overcome the aforementioned problem, a first invention is directed to an information providing apparatus for a vehicle, and the information providing apparatus for a vehicle includes: a display section configured to provide information by screen display; and a display control section capable of displaying, on the display section, a first screen based on a first display request, and thereafter displaying, on the display section, a second screen based on a second display request. The display control section continuously displays the first screen on the display section according to contents of the first screen, in a case where the first display request is cancelled before a continuous display time in which the first screen based on the first display request has been continuously displayed on the display section, reaches a predetermined reference time. After display of the first screen has been continued and before the continuous display time of the first screen reaches the reference time, the display control section switches, in a case where the second display request making an instruction for displaying the second screen to be displayed at a highest priority occurs, the display of the display section from the first screen to the second screen at a time when the second display request occurs, and displays, in a case where the second display request does not occur, the first screen on the display section until the continuous display time of the first screen reaches the reference time.

According to the first invention, in a case where a request for displaying the first screen is cancelled while the first screen is being displayed, and the first screen is to be displayed only in the continuous display time that has not reached the reference time, display of the first screen is continued until the reference time is reached. For the reference time, for example, a time in which a driver or the like may not feel instantaneous display or is less likely to feel instantaneous display in the screen displayed on the display section, is set. Thus, a phenomenon that the first screen is displayed only for an instant due to the driver cancelling the display request or another display request occurring, is avoided, and instantaneous display of information can be inhibited from occurring.

Meanwhile, in a case where a request for displaying the second screen to be displayed at a highest priority occurs while display of the first screen is being continued until the reference time is reached, display of the first screen which is being continuously displayed, is ended, and display of the second screen is immediately started. Thus, screen display of information having a high urgency can be performed more preferentially than inhibition of occurrence of instantaneous display of information, and necessary information can be provided to a driver in real time.

Further, according to a second invention based on the first invention, before the continuous display time of the first screen reaches the reference time, the display control section switches, in a case where the second display request making an instruction for displaying the second screen to be displayed at the highest priority occurs, display of the display section from the first screen to the second screen at a time when the second display request occurs, and the display control section displays, in a case where the second display request does not occur, the first screen on the display section until the continuous display time of the first screen reaches the reference time.

According to the second invention based on the first invention, before the continuous display time of the first screen reaches the reference time, the display control section switches, in a case where the second display request making an instruction for displaying the second screen to be displayed at the highest priority occurs, display of the display section from the first screen to the second screen at a time when the second display request occurs, and the display control section displays, in a case where the second display request does not occur, the first screen on the display section until the continuous display time of the first screen reaches the reference time.

Meanwhile, in a case where a request for displaying the second screen to be displayed at the highest priority occurs while the first screen is being displayed until the reference time is reached, display of the first screen is ended, and display of the second screen is immediately started. Thus, screen display of information having a high urgency can be performed more preferentially than inhibition of occurrence of instantaneous display of information, whereby necessary information can be provided to a driver in real time.

Further, according to a third invention based on the first invention, in a case where the first screen is a predetermined screen, the display control section ends display of the first screen on the display section at a time when the first display request is cancelled.

According to the third invention based on the first invention, a state in which, when a driver to whom information has been provided executes some operation, information that is different from information representing change of a state based on the operation is displayed on the screen, can be avoided. Thus, a driver can be inhibited from feeling uneasy due to disagreement between the information. and an actual vehicle state or the like.

As described above, the information providing apparatus, for a vehicle, according to the present invention allows information having a high priority to be preferentially displayed in real time while inhibiting occurrence of instantaneous display of information.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a schematic configuration of a vehicle system that includes an information providing apparatus, for a vehicle, according to one embodiment of the present invention;

FIG. 2 illustrates an example of a screen displayed on a display section;

FIG. 3 to FIG. 9 are each a timing chart (a scene 1 to a scene 7) showing a correspondence between a screen display request received by a request reception section and a screen displayed on the display section; and

FIG. 10 illustrates a schematic configuration of a vehicle system that includes an information providing apparatus, for a vehicle, according to reference example of the present invention.

### DESCRIPTION OF THE PREFERRED EMBODIMENTS

[Outline]

In an information providing apparatus, for a vehicle, according to the present invention, in a case where screen display is to be performed only for an instant in which instantaneous display of information may occur, the screen display is continued until a reference time when instantaneous display is less likely to be felt. Meanwhile, even while the screen display until the reference time is being continued, if information having a high urgency occurs, the information is preferentially displayed on the screen. Thus, while information having a high priority is preferentially displayed in real time, instantaneous display of information is inhibited from occurring.

Hereinafter, an information providing apparatus, for a vehicle, according to the present invention will be described in detail with reference to the drawings.

[Configuration of Vehicle System]

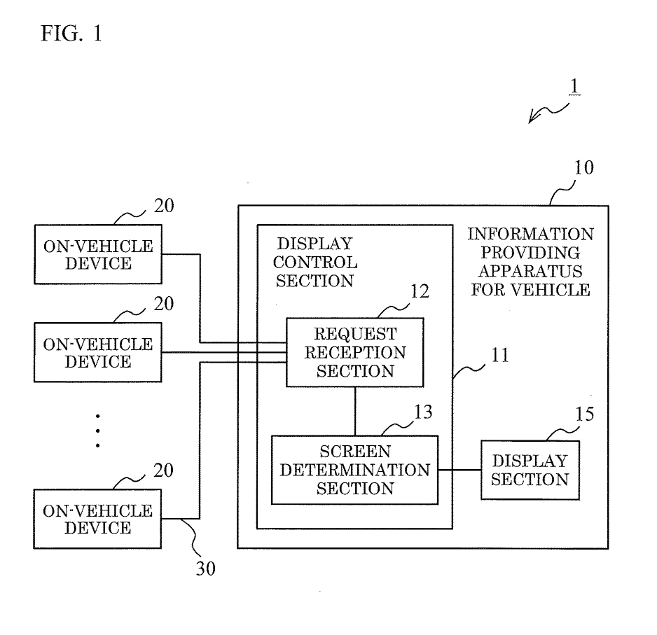

FIG. 1 illustrates a schematic configuration of a vehicle system 1 that includes an information providing apparatus 10, for a vehicle, according to one embodiment of the present invention. In the vehicle system 1 shown in FIG. 1, the information providing apparatus 10 for a vehicle is connected to a plurality of on-vehicle devices 20 via an on-vehicle network 30 such as a CAN (Control Area Network).

The information providing apparatus 10 for a vehicle includes: a display control section 11 that has a request reception section 12 and a screen determination section 13; and a display section 15, as shown in FIG. 1.

The request reception section 12 receives screen display requests (signals) described below, from the plurality of on-vehicle devices 20, at any time. The request reception section 12 notifies the screen determination section 13 that the screen display requests (signals) have been received.

The screen determination section 13 determines a screen to be displayed on the display section 15, a screen display time, and a screen display order, based on one or a plurality of screen display requests (signals) the notification of which has been made by the request reception section 12. The contents to be determined by the screen determination section 13 will be described below. The screen determination section 13 provides the display section 15 with an instruction based on the determined contents, thereby controlling a screen to be displayed on the display section 15. Display modes (graphics, texts, colors, or the like) for screens to be displayed on the display section 15 may be previously stored in a not-illustrated storage section or the like so as to correspond to the information.

The display section 15 displays a predetermined screen for a predetermined display time in a predetermined display order, according to the instruction from the screen determination section 13. The display section 15 that is effective in the present invention is a display section that is limited in, for example, size and the number of pieces of information which can be simultaneously displayed. The display section 15 may be, for example, an information display incorporated in a meter, or a head up display (HUD) that is formed on a windshield of a vehicle by projection using a light projector.

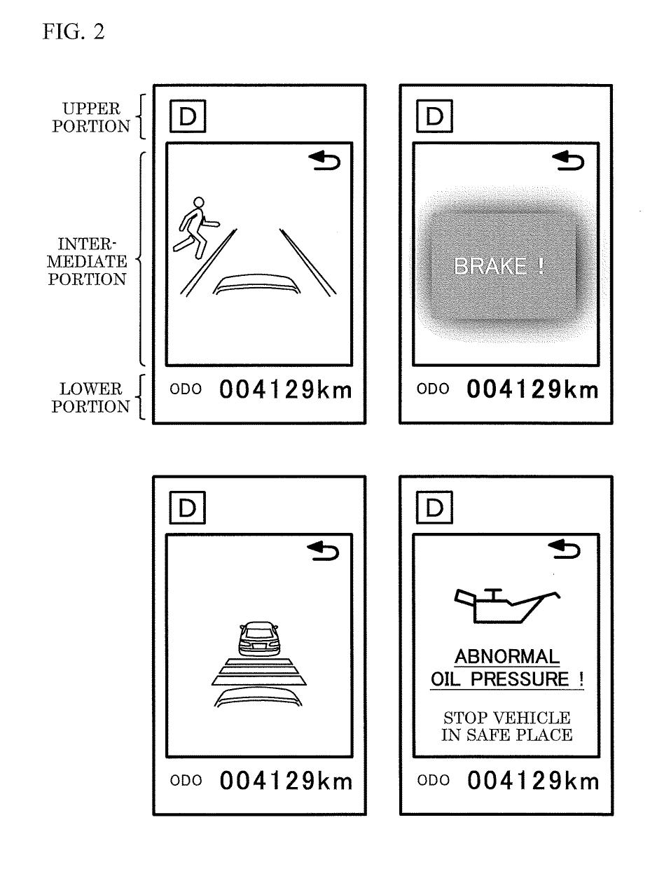

FIG. 2 illustrates an example of a screen displayed on the display section 15. As shown in FIG. 2, information concerning a shift position is constantly displayed in the upper portion of the screen, and information concerning running distance is constantly displayed in the lower portion of the screen. According to an instruction from the display control section 11, switching of information is performed as appropriate and a single piece of information is variously displayed at the intermediate portion of the screen. As in the example shown in FIG. 2, an object of the present invention is to control screen display concerning the single piece of information displayed at the intermediate portion of the screen.

The on-vehicle devices 20 are each an electronic control unit (ECU) mounted to a vehicle for controlling the vehicle and obtaining information from the vehicle, and are, for example, an engine ECU, a brake ECU, an advanced safety ECU, and a radar ECU. The electronic control unit typically includes a central processing unit (CPU), a memory, an input/output interface, and the like. The CPU reads a program stored in the memory, and interprets and executes the program, to exhibit various functions.

In a case where the on-vehicle device 20 has a predetermined piece of information to be displayed on the screen by the display section 15 of the information providing apparatus 10 for a vehicle, the on-vehicle device 20 transmits a screen display request (signal) for requesting display of a screen corresponding to the predetermined piece of information, via the on-vehicle network 30, to the request reception section 12 of the information providing apparatus 10 for a vehicle. In the present embodiment, for facilitating the description, the screen display request (signal) is described by using, as an example, a binary signal that indicates whether or not a screen that can be identified by the information providing apparatus 10 for a vehicle is to be displayed on the display section 15. However, the screen display request (signal) may include identification information that uniquely identifies a display screen, or information concerning the display mode of the display screen as described above.

The screen display request (signal) transmitted by each on-vehicle devices 20 is previously assigned a stepwise priority (for example, level 5 to level 1) according to contents of the information which are requested to be displayed on the screen. For example, information, having a high urgency, such as information concerning failure in brake and information concerning leakage of engine oil is to be provided to a driver in real time, whereby the information having a high urgency is assigned highest priority (for example, level 5). Meanwhile, information, having a low urgency, such as information concerning a distance to a preceding vehicle, information indicating that the vehicle is approaching a position at which temporary stop is to be performed, or information concerning a remaining amount of battery, need not be provided to a driver in real time, and is thus assigned a priority (for example, level 4 to level 1) based on an importance of each piece of information. The priority of the information is used by the screen determination section 13 for determining a screen to be displayed on the display section 15, a screen display time, and a screen display order.

[Control by Information Providing Apparatus for Vehicle]

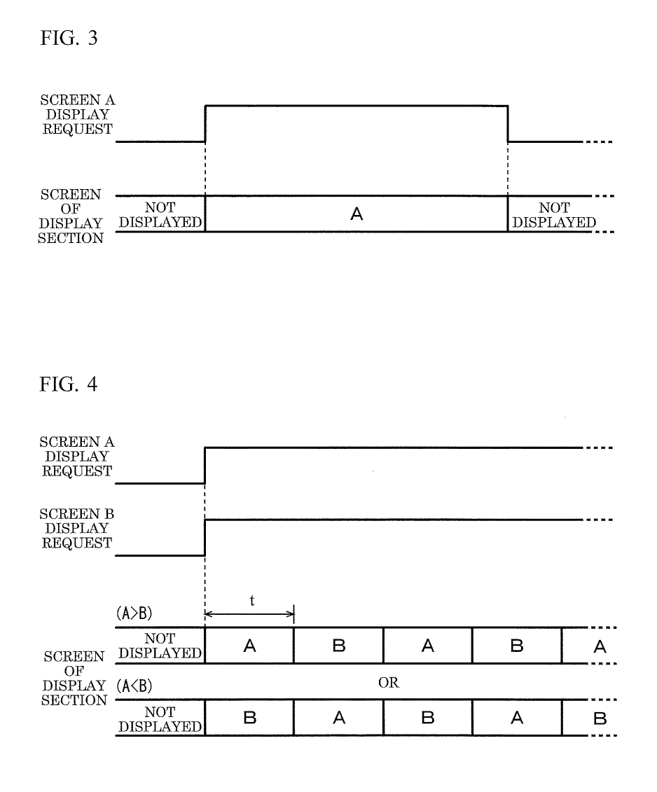

Next, the control executed by the information providing apparatus 10 for a vehicle will be described with further reference to FIG. 3 to FIG. 9. FIG. 3 to FIG. 9 are each a timing chart showing a correspondence between: the screen display request received by the request reception section 12 of the information providing apparatus 10 for a vehicle; and a screen to be displayed on the display section 15 of the information providing apparatus 10 for a vehicle, a screen display time, and a screen display order.

FIG. 3 illustrates a scene 1 in which only a screen A display request corresponding to information A is received. In the scene 1, the screen A is displayed only in a time period in which the screen A display request occurs.

FIG. 4 illustrates a scene 2 in which the screen A display request corresponding to the information A and a screen B display request corresponding to information B are both received. In the scene 2, the screen A and the screen B are alternately displayed in an order starting from the information having a higher priority such that each screen is displayed for a predetermined time period t (for example, for 6 seconds). A time period in which the screen A is displayed and a time period in which the screen B is displayed, are each a time period in which the corresponding screen display request occurs. Needless to say, also in a case where three or more screen display requests are received collectively, three or more screens are similarly displayed sequentially in an order starting from the screen having a higher priority.

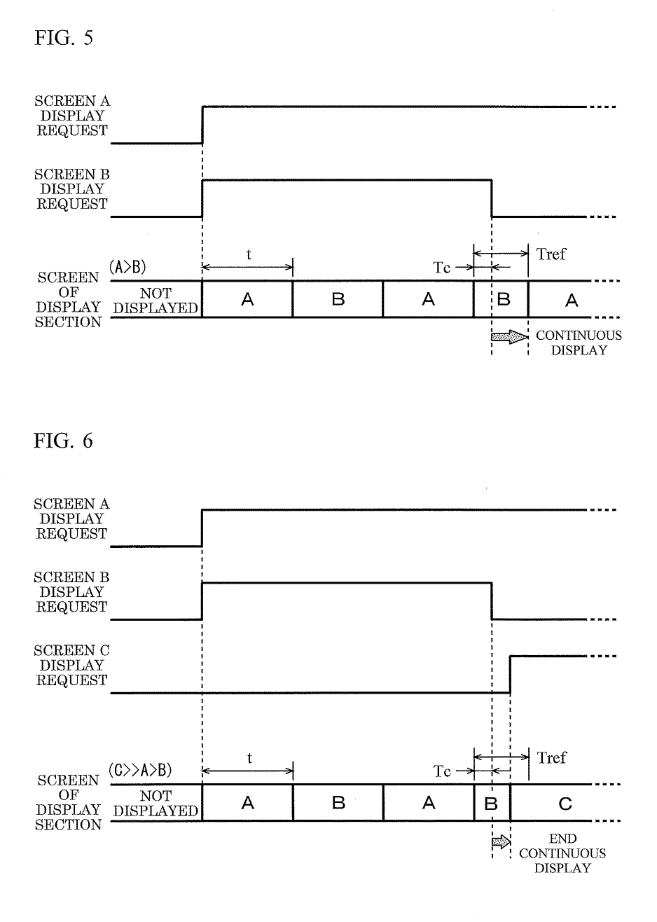

FIG. 5 illustrates a scene 3 in which the screen A display request corresponding to the information A and the screen B display request corresponding to the information B are both received (priority: A>B), and the screen B display request is cancelled halfway. In the scene 3, the screen B display request is cancelled while the screen B is being displayed. Conventionally, at a point of time when the screen B display request is cancelled, the display of the screen B is immediately ended, whereby the “instantaneous display” occurs due to the screen B being displayed for a short time period. Meanwhile, in the present invention, a time (hereinafter, referred to as a “continuous display time To”) in which display of the screen B has been continued until cancel of the screen B display request, is determined. When the continuous display time Tc has not reached a predetermined reference time Tref, display of the screen B is continued until the reference time Tref is reached even when the screen B display request has been cancelled.

For the reference time Tref, a time when a driver or the like may not feel instantaneous display or is less likely to feel instantaneous display in the screen displayed on the display section 15, is set. For example, according to a result of an experiment by the inventors, subjects to be tested in the experiment did not feel instantaneous display in a screen that was continuously displayed for at least 0.9 seconds. Thus, in a case where display of the screen B is continued for at least the reference time Tref, instantaneous display in display of the screen B, that is, instantaneous display of the information B can be inhibited from occurring.

FIG. 6 illustrates a scene 4 in which, while display of the screen B is being continued in the scene 3 shown in FIG. 5, a screen C display request corresponding to information C having the highest priority (priority: C>>A>B) is received. In the scene 4, although the continuous display time Tc of the screen B has not reached the reference time Tref, and the display of the screen B is being continued, the information C having the highest priority is to be provided to a driver in real time and the screen C is thus displayed. That is, the display of the screen B is ended, and display of the screen C is immediately started.

Thus, real time display of information having a high urgency can be performed more preferentially than inhibition of occurrence of instantaneous display of information.

The screen switching control as indicated in the scene 4 is performed not according to relative comparison among the priorities, but according to absolute comparison of the priorities. That is, in the example of the scene 4 shown in FIG. 6, the screen switching control is not performed since the priority of the information C (screen C) is higher than the priority of the information B (screen B), and the screen switching control is performed when the priority of the information C (screen C) represents a predetermined level (for example, level 5).

FIG. 7 illustrates a scene 5 in which the screen A display request corresponding to the information A and the screen B display request corresponding to the information B are both received at different times, and the priority of the information A is lower than the priority of the information B (priority: A<B). In the scene 5, similarly to the scene 2 shown in FIG. 4, the screen A and the screen B are alternately displayed in the order starting from the screen B corresponding to the information B having a higher priority such that each screen is displayed for a predetermined time period t (for example, for 6 seconds).

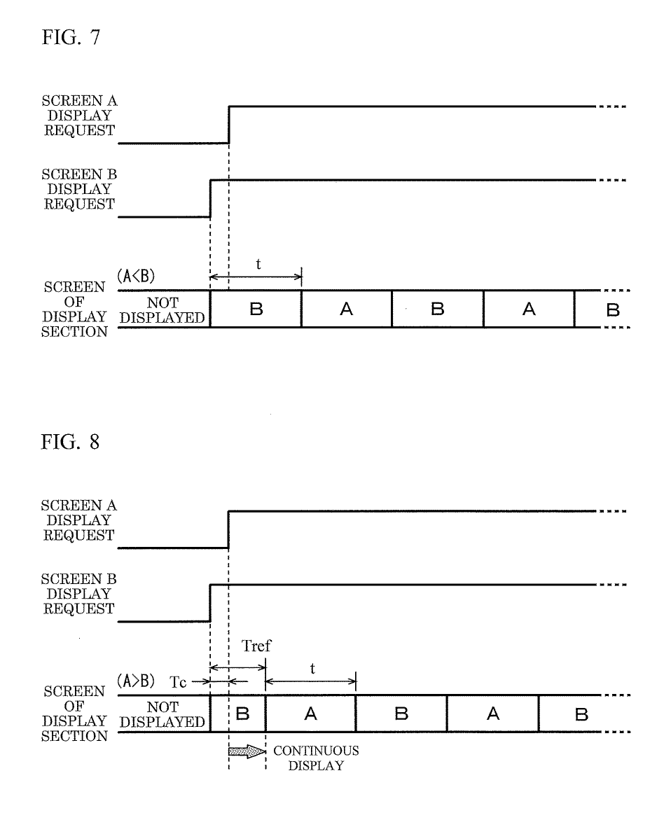

FIG. 8 illustrates a scene 6 in which the screen A display request corresponding to the information A and the screen B display request corresponding to the information B are both received at different times, and the priority of the information A is higher than the priority of the information B (priority: A>B). In the scene 6, while the screen B is being displayed, the screen A display request corresponding to the information A having a priority higher than the information B occurs. Conventionally, at a point of time when the screen A display request is received, display of the screen B is immediately ended and display of the screen A is started, whereby “instantaneous display” occurs due to the screen B being displayed for a short time period. Meanwhile, in the present invention, the continuous display time Tc in which display of the screen B has been continued, is determined. When the continuous display time Tc has not reached the reference time Tref, even if the screen A display request has occurred, display of the screen B is continued until the reference time Tref is reached.

Thus, display of the screen B is continued for at least the reference time Tref, whereby instantaneous display in display of the screen B, that is, instantaneous display of the information B can be inhibited. In this case, a time period in which display of the screen B is continued may be set as a time period longer than the reference time Tref (for example, 6 seconds).

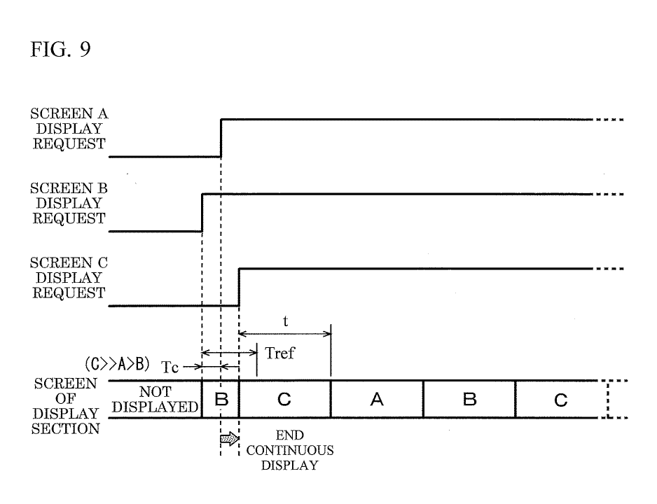

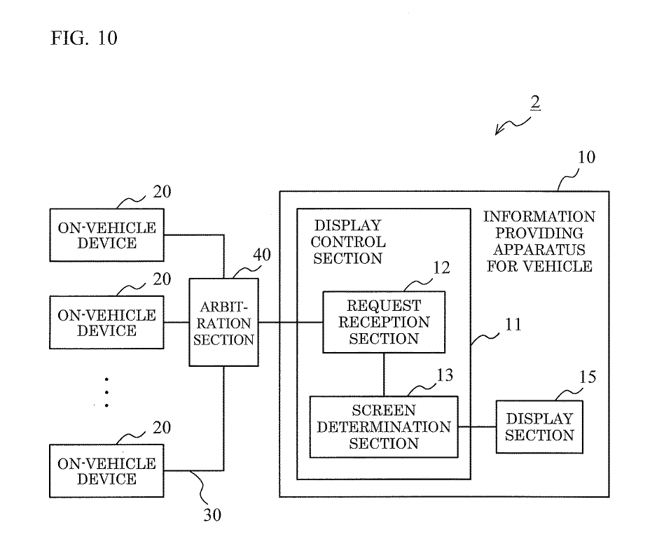

FIG. 9 illustrates a scene 7 in which, while display of the screen B is being continued in the scene 6 shown in FIG. 8, the screen C display request corresponding to the information C having the highest priority is received (priority: C>>A>B). In the scene 7, although the continuous display time Tc of the screen B has not reached the reference time Tref, and the display of the screen B is being continued, the information C having the highest priority is to be provided to a driver in real time and the screen C is thus displayed. That is, the display of the screen B is ended, the display of the screen C is immediately started.

Thus, real-time display of the information having a high urgency can be performed more preferentially than inhibition of occurrence of instantaneous display of information. The screen switching control indicated in the scene 7 is also performed not according to relative comparison among priorities, but according to absolute comparison of priorities, as described above.

In the above basic description, in a case where the continuous display time Tc of a screen corresponding to information has not reached the reference time Tref, even if the screen display request corresponding to the information is cancelled, or a screen display request corresponding to information having a priority higher than the above information occurs, the display of the screen corresponding to the preceding information is continued until the reference time Tref is reached (the scene 3 and the scene 6). However, in a case where the preceding information displayed on the screen is information that need not be continuously displayed on the screen, even if the continuous display time Tc of the screen has not reached the reference time Tref, the display of the screen corresponding to the preceding information may be ended at a time when the screen display request corresponding to the preceding information is cancelled, or at a time when the screen display request corresponding to information having a priority higher than the preceding information occurs.

The information that need not be continuously displayed on the screen is, for example, information that is provided to a driver such that the driver executes some operation and the driver is allowed to recognize change of a state according to the operation. For example, in a case where information represents a half-shut state of a door, when the driver has shut the door on receipt of the information, the half-shut state of the door has been overcome, and the screen display request corresponding to the information is to be cancelled. If, even in such a state, it is determined that the reference time Tref has not been reached, and display of the screen representing the half-shut state of the door is continued, information that is different from information representing the change of the state based on the operation is displayed on the screen, resulting in the driver feeling rather uneasy.

Therefore, exceptionally, the information that need not be continuously displayed is not continuously displayed on the screen until the reference time Tref is reached. Thus, information that represents a state different from an actual vehicle state or the like can be prevented from being displayed on the screen. Therefore, a driver can be inhibited from feeling uneasy due to disagreement between the information, and an actual vehicle state or the like.

[Operation and Effect of Embodiment]

As described above, in the information providing apparatus, for a vehicle, according to one embodiment of the present invention, in a case where screen display is to be performed only for an instant in which instantaneous display of the information may occur, depending on: whether or not a screen display request (signal) corresponding to information has occurred; a time when the screen display request (signal) corresponding to the information has occurred; a priority of the information; or the like, display of the screen is continued until the reference time Tref is reached. For the reference time Tref, a time when a driver or the like may not feel instantaneous display or is less likely to feel instantaneous display in the screen displayed on the display section 15, is set, whereby instantaneous display of the information can be inhibited from occurring.

Meanwhile, in a case where, while display of the screen is being continued until the reference time Tref is reached in order to inhibit instantaneous display of the information from occurring, a screen display request corresponding to information having a high urgency is received, the display of the screen which is being continued is ended, and display of the screen corresponding to the information having the high urgency is immediately started. Thus, screen display of the information having a high urgency can be performed more preferentially than inhibition of occurrence of instantaneous display of information, and necessary information can be provided to a driver in real time.

### Reference Example

In the vehicle system 1 according to the above-described embodiment, each of the plurality of on-vehicle devices 20 transmits a screen display request (signal) via the on-vehicle network 30 to the information providing apparatus 10 for a vehicle. Therefore, the information providing apparatus 10 for a vehicle needs to process a plurality of the screen display requests (signals).

In reference example, as in a vehicle system 2 shown in FIG. 10, an arbitration section 40 performs arbitration of the plurality of screen display requests (signals) transmitted by the plurality of the on-vehicle devices 20, respectively, to generate one screen display request (signal), and transmits the one screen display request (signal) to the information providing apparatus 10 for a vehicle. Thus, the information providing apparatus 10 for a vehicle may process only one screen display request (signal), thereby reducing processing load.

While the invention has been described in detail, the foregoing description is in all aspects illustrative and not restrictive. It will be understood that numerous other modifications and variations can be devised without departing from the scope of the invention.

What is claimed is:

1. An information providing apparatus for a vehicle, the information providing apparatus comprising:
a display section configured to provide information by screen display; and
a display control section capable of displaying, on the display section, a first screen based on a first display request, and thereafter displaying, on the display section, a second screen based on a second display request, wherein
the display control section continuously displays the first screen on the display section according to contents of the first screen, in a case where the first display request is cancelled before a continuous display time in which the first screen based on the first display request has been continuously displayed on the display section, reaches a predetermined reference time, and
after display of the first screen has been continued and before the continuous display time of the first screen reaches the reference time,
the display control section switches, in a case where the second display request making an instruction for displaying the second screen to be displayed at a highest priority occurs, the display of the display section from the first screen to the second screen at a time when the second display request occurs, and displays, in a case where the second display request does not occur, the first screen on the display section until the continuous display time of the first screen reaches the reference time.

2. The information providing apparatus, for a vehicle, according to claim 1, wherein
before the continuous display time of the first screen reaches the reference time,
the display control section switches, in a case where the second display request making an instruction for displaying the second screen to be displayed at the highest priority occurs, display of the display section from the first screen to the second screen at a time when the second display request occurs, and
the display control section displays, in a case where the second display request does not occur, the first screen on the display section until the continuous display time of the first screen reaches the reference time.

3. The information providing apparatus, for a vehicle, according to claim 1, wherein, in a case where the first screen is a predetermined screen, the display control section ends display of the first screen on the display section at a time when the first display request is cancelled.
